(19) United States
(12) Patent Application Publication
(10) Pub. No.: US 2008/0275767 A1
(43) Pub. Date: Nov. 6, 2008

(54) Dynamic Creation of an Online Contest or Poll

(76) Inventor: Reza Rafie, Herndon, VA (US)

Correspondence Address: Capitol IP, 10480 Little Patuxent Parkway, Suite 400, Columbia, MD, 21044, US

(21) Appl. No.: 11/743,387

(22) Filed: May 2, 2007

(51) Int. Cl. G06Q 90/00

(52) U.S. Cl. 705/12

(57) ABSTRACT

A method and a system are provided, such that a subscriber may access a remote processing device to dynamically create or edit an online contest or an online poll. When creating an online contest, the subscriber may provide the remote processing device with contest information including contest rules, contest entrance criteria, access control information, a format for contest submissions, and/or other information. When creating an online poll, the subscriber may provide the remote processing device with information including a poll question, poll answers, a poll category, poll entrance criteria, poll access control information, and/or other poll information. In some embodiments, the subscriber may create one or more access lists to limit access to an online poll or an online contest, to limit viewing of the online poll or the online contest, or to limit participation of users with respect to the online poll of the online contest.

### BACKGROUND

Many users online have enjoyed participating in online contests or polls. Some existing online contests or polls may permit any online user to participate, while other existing online contests or polls may permit only certain individuals to participate, such as, for example, only members of a particular group or organization, or only those who enter a particular access code. Other online contests or polls may only permit individuals to participate upon paying a fee.

Generally, online contests or polls are predefined. That is, one may not define or create a contest or poll dynamically. To create an online contest or poll, a contest or poll creator may submit a request with a description of an online contest or poll. The contest or poll creator may then wait until a third-party sets up the online contest or poll, according to the contest or poll creator's request. The contest creator may specify rules for scoring contest entries, but he or she may have no way to easily change the rules, or may have no way to easily change who may participate in scoring contest entries.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, a subscriber may access a remote processing device, via a network, to dynamically create or edit an online contest or an online poll. When creating an online contest, the subscriber may provide information, such as, for example, a contest title, contest rules and a description, entrance criteria, access control information, information indicating a format for contest submissions, a contest start date, a contest end date, one or more scoring categories, a contest status, or other contest information.

When creating an online poll, the subscriber may provide information, such as, for example, a poll title, a poll question, at least two poll answers, a poll category, a poll start date, a poll end date, a poll status, an entrance criteria, poll access control information, or other poll information.

In some embodiments, the subscriber may create one or more access lists to limit access to an online poll or an online contest, to limit viewing of the online poll or the online contest, or to limit participation of users with respect to the online poll or the online contest.

In various embodiments consistent with the subject matter of this disclosure, a contest creator/designer or a poll creator/designer may define characteristics of a desired user, and users having the defined characteristics may be contacted automatically invited to participate in an online poll or an online contest.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment in which embodiments consistent with the subject matter of this disclosure may operate.

FIG. 2 is a functional block diagram illustrating a processing device, which may be used to implement embodiments consistent with the subject matter of this disclosure.

FIGS. 3A-3D are flowcharts illustrating an exemplary process for creating or editing an online contest or in online poll.

FIG. 4 is a flowchart illustrating an exemplary process for creating a contest scoring category for an online contest.

FIG. 5 is a flowchart illustrating an exemplary process for creating an access list.

FIG. 6 is a flowchart illustrating an exemplary process that may be performed when a user requests to join an online contest.

FIGS. 7 is a flowchart illustrating an exemplary process that may be performed when a user requests access to score and view an online contest.

FIG. 8 is a flowchart illustrating an exemplary process that may be performed when a contest creator/designer or a poll creator/designer requests access to assign an access restriction to an online poll or an online contest.

FIG. 9 is a flowchart illustrating an exemplary process that may be performed when a subscriber assigns an access list to an online contest or to online poll.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Overview

In embodiments consistent with the subject matter of this disclosure, a subscriber or user may use a processing device to access a second processing device, via a network, to dynamically create online contests or online polls. When creating an online contest, the user may be prompted to provide information, such as, for example, a contest title, contest rules and a description, entrance criteria, access control information, a contest category, a contest subcategory, a contest start date, a contest end date, one or more scoring categories, a contest status, one or more contest prizes and details on how to collect or win a prize, or other contest information.

When creating an online poll, the user may be prompted to provide information, such as, for example, a poll title, a poll question, poll answers, a poll category, a poll start date, a poll end date, a poll status, entrance criteria, poll access control information, or other poll information.

In some embodiments, the subscriber may create one or more access lists for limiting access to an online poll or an online contest, or for limiting participation of users with respect to scoring. Further, the entrance criteria may include a definition of a profile of a user permitted to participate in the online contest or the online poll. Users having a matching profile may be contacted automatically via e-mail, text messaging, instant messaging, voice mail, or another messaging method.

### Exemplary Operating Environment

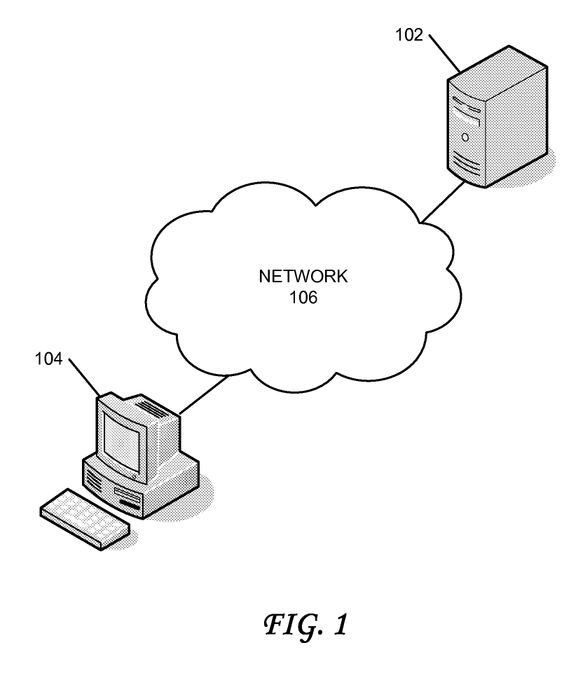

FIG. 1 illustrates an exemplary environment in which embodiments consistent with the subject matter of this disclosure may operate. The exemplary environment may include a first processing device 102, a second processing device 104, and a network 106.

First processing device 102 may be a server, a personal computer (PC), a handheld processing device, or other processing device.

Second processing device 104 may be a subscriber's processing device or a user's processing device. Second processing device 104 may be a PC, a handheld processing device, or other processing device.

Network 106 may be a single network or a number of connected networks, such as, for example, the Internet, or other networks. In some embodiments, network 106 may include any combination of wired networks, wireless networks, optical networks, and other types of networks. First processing device 102 and second processing device 104 may access network 106 via a wired, wireless, or optical connection.

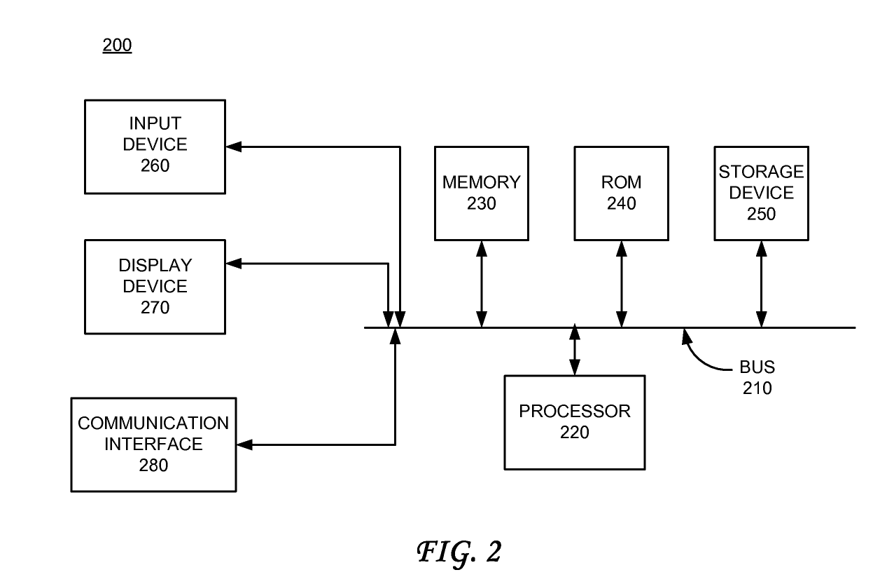

FIG. 2 is a functional block diagram that illustrates processing device 200, which may be used to implement embodiments of first processing device 102 or second processing device 104 consistent with the subject matter of this disclosure. Processing device 200 may include a bus 210, a processor 220, a memory 230, a read only memory (ROM) 240, a storage device 250, an input device 260, an output device 270, and a communication interface 280. Bus 210 may permit communication among components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media for storing data and/or instructions.

Input device 260 may include a keyboard, a microphone, or other input device. Output device 270 may include one or more conventional mechanisms that output information to the user, including one or more displays, printers, speakers, or other output devices. Communication interface 280 may include any transceiver-like mechanism that enables processing device 200 to communicate with other devices or networks. In one embodiment, communication interface 280 may include a wireless or wired interface.

Processing device 200 may perform such functions in response to processor 220 executing sequences of instructions contained in a tangible machine-readable medium, such as, for example, memory 230, or other medium. Such instructions may be read into memory 230 from another machine-readable medium, such as storage device 250, or from a separate device via communication interface 280.

### Exemplary Processing

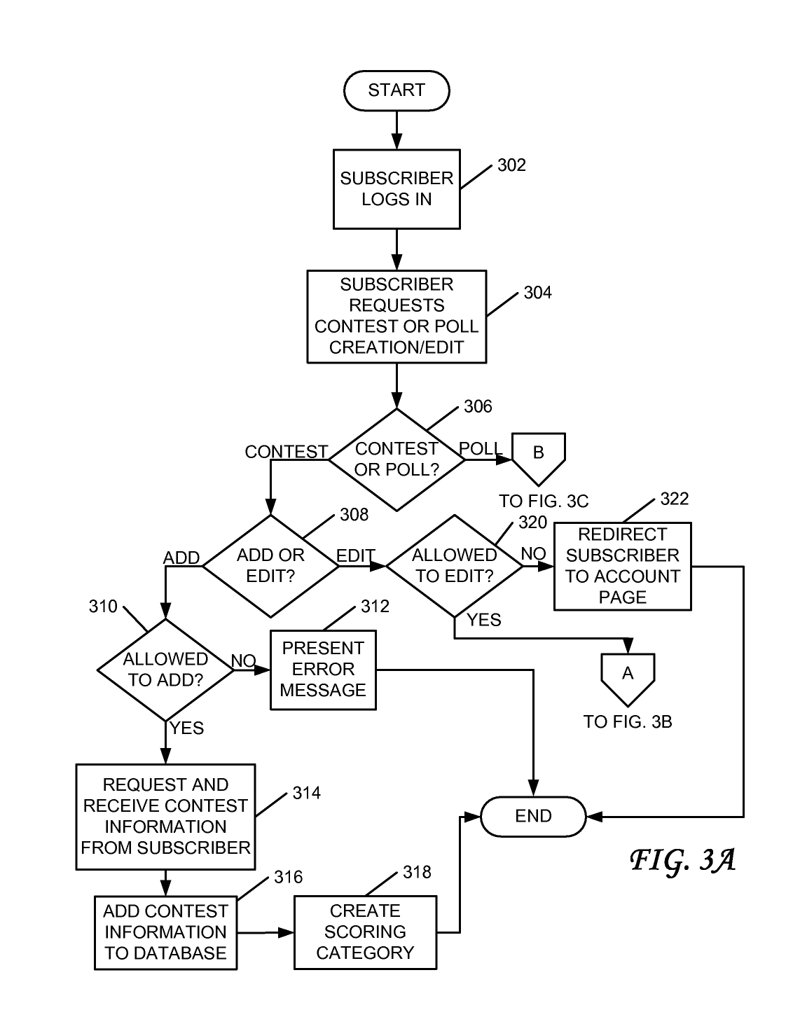

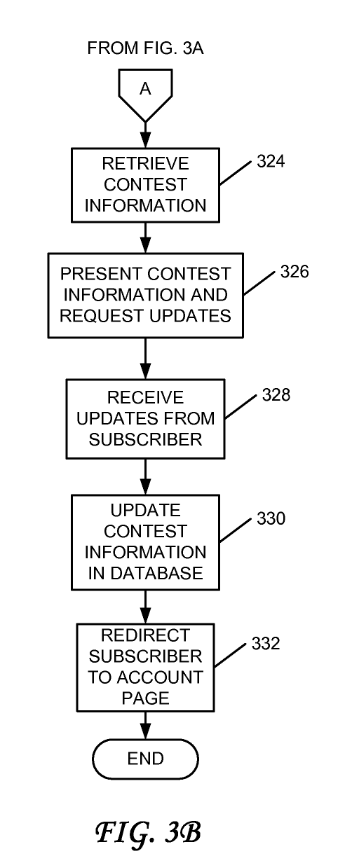

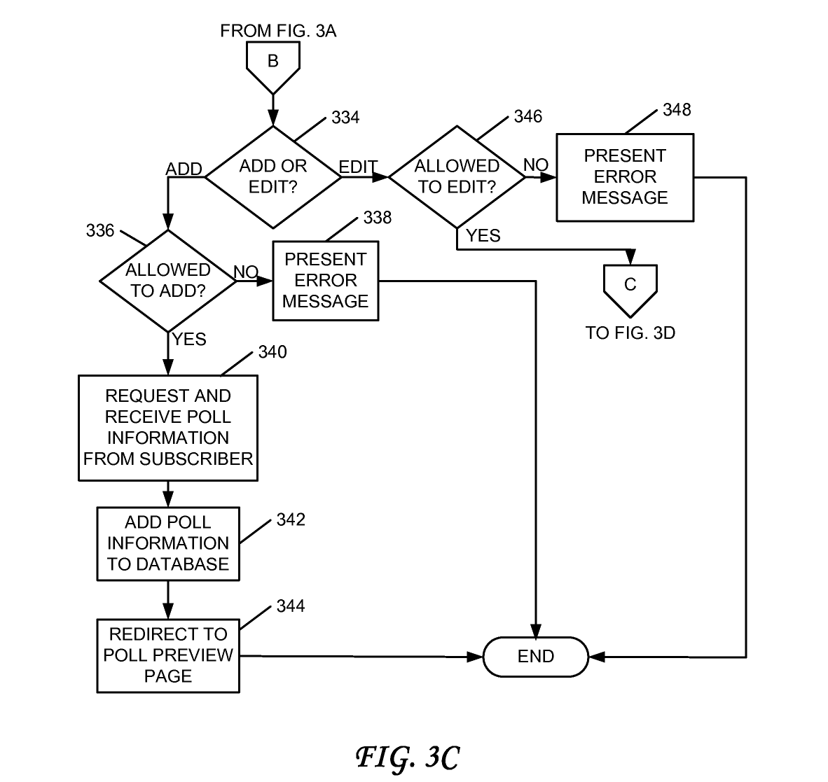

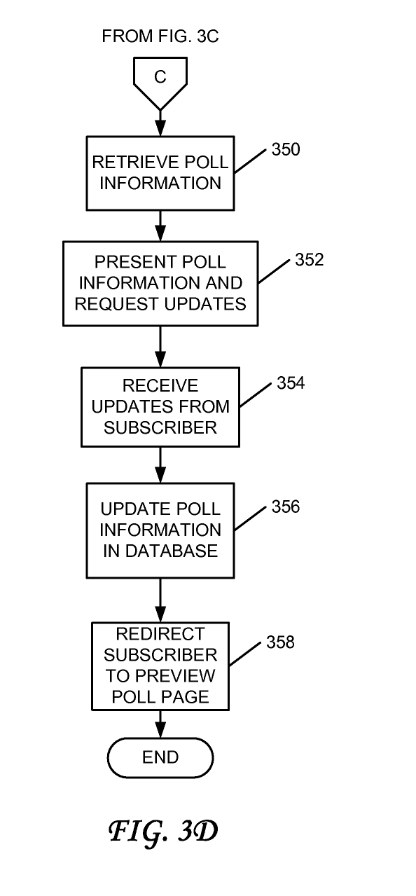

FIGS. 3A-3D are flowcharts that illustrate an exemplary process for dynamically creating an online contest poll. The process may begin with a subscriber logging in to a first processing device, such as, for example, first processing device 102, via a second processing device, such as, for example, second processing device 104, and a network, such as, for example, network 106 (act 302). In one embodiment, the subscriber may login to the first processing device by using a web browser, such as, for example, Internet Explorer® available from Microsoft Corp. of Redmond, Wash., or another web browser, executing on the second processing device. The user may enter an address of an online contest or poll website to access the first processing device and be presented with a login prompt. After logging in, the subscriber may enter a request to the first processing device, via the second processing device, to create or edit an online contest or an online poll (act 304). The first processing device may then determine whether the subscriber requested creation or editing of an online contest or an online poll (act 306).

If the subscriber requested creation or editing of an online contest, then the first processing device may determine whether a new online contest is to be added or whether an existing online contest is to be edited (act 308). If the first processing device determines that a new online contest is to be added, then the first processing device may determine whether the subscriber is permitted to add the new online contest (act 3 10). For example, in some embodiments, the subscriber may be permitted to create or add only a predetermined number of online contests, such as, for example, five online contests, or another number of online contests. In other embodiments, other conditions may exist which may not permit the subscriber to add a new online contest. If the first processing device determines that the subscriber is not allowed to add a new online contest, then the first processing device may present an error message to the subscriber via the second processing device, informing the subscriber that he or she is not permitted to create the new contest (act 312) and the process may end.

If, at act 310, the first processing device determines that the subscriber is allowed to add a new online contest, then the first processing device may request and receive contest information from the subscriber (act 314). In one embodiment consistent with the subject matter of this disclosure, the first processing device may cause a form to be presented to the subscriber via the network and the second processing device. The subscriber may complete the form and submit the form to the first processing device via the network. The form may request the subscriber to provide information including, but not limited to: a contest title; a contest description and contest rules; one or more entrance criteria (for example, age, gender, race, country, state, county, city, zip code, e-mail address, domain name of the e-mail address, username, family income, marital status, contest ranking category, number of submissions for a contest, or other entrance criteria), contest access control information, a contest category, a contest subcategory, a contest start date, a contest end date, one or more scoring categories, or one or more prizes. In other embodiments, the subscriber may provide different or other information when creating an online contest.

In some embodiments, the contest description and the contest rules may include information with respect to one or more prizes and how to win the one or more prizes.

Although the entrance criteria may control participation in an online contest by a user, the entrance criteria may not prevent users from viewing the online contest and online contest submissions. The contest access control information may provide a subscriber, such as a contest creator/designer, one way to restrict viewing and/or participation in the online contest. In one embodiment, the access control information may include an access list having user names or e-mail addresses of users the subscriber wishes to permit to enter a contest. In some embodiments, the access control information may further include a password or an access code, which a user may be required to provide in order to be permitted to participate in or view the online contest.

The contest category may include one of a number of categories, such as, for example, video, audio, image, text, or other or different categories. In one embodiment, the first processing device may validate contest entries as conforming to a file format appropriate for the contest category. For example, if the selected contest category is video, then the first processing device may validate contest entries as having a video format.

The contest subcategory may depend on the selected contest category. For example, when the selected contest category is text, the subscriber may be requested to select a contest subcategory from one of: articles; poems; stories; academics; or other. When the selected contest category is a category other than text, the subscriber may be requested to select a contest subcategory from a number of different choices.

The contest start date may be a date upon which users may join the contest and submit contest entries. The contest end date may be a date, upon which, users may no longer join the contest and may no longer submit contest entries.

A contest scoring category may include a scoring start date, a scoring end date, a scoring category name, scoring rules, a scoring method, and judges. In other embodiments, the contest scoring category may include other or different information. The scoring start date may be a date, after the contest end date, upon which a designated panel of judges or other users may score, grade, or vote with respect to the contest entries. The scoring end date may be a date upon which the first processing device may prevent further scoring of the contest entries. The scoring category name may be a name assigned to the scoring category. The scoring rules may include a definition of a scoring process for the contest. The scoring method may be a scoring method selected from among a number of possible scoring methods, such as, for example, “0 to 5”, “0 to 10”, “0 to 100”, “A, B, C, D, F”, or other or different scoring methods. Judges may be designated for scoring purposes by the subscriber by providing an access list of user names, email addresses, or other information corresponding to permitted judges.

After receiving the contest information from the subscriber, the first processing device may add the contest information to a database (act 316) and may create one or more scoring categories, according to the contest information provided during act 314 (act 318).

If, during act 308, the first processing device determines that that the subscriber requested editing of contest information of an existing online contest, then the first processing device may determine whether the subscriber is permitted to edit the contest information of the existing online contest (act 320). For example, in one embodiment, the subscriber may not be permitted to edit the contest information with respect to an online contest after the contest end date. If the subscriber is not permitted to edit the contest information, then the first processing device may redirect the subscriber to another page, such as, for example, an account page, which may provide the subscriber with information about his or her account, or another page (act 322). The process may then end.

If, during act 320, the first processing device determines that the subscriber is permitted to edit the contest information of the existing online contest, then the first processing device may retrieve the contest information from a database (act 324; FIG. 3B). The first processing device may then provide the contest information to the second processing device, via the network, for presentation to the subscriber and may request the subscriber to update the contest information (act 326). The second processing device may then receive updated contest information from the subscriber (act 328) and may provide the updated contest information to the first processing device, which may then update the contest information in the database (act 330). The first processing device may then redirect the subscriber, such that the subscriber may be presented with another page, such as, for example, the account page, or a different page (act 332). The process may then end.

If, during act 306, the first processing device determines that the subscriber is requesting to create a new online poll or edit an existing online poll, then first processing device may determine whether the subscriber is requesting to add a new online poll or to edit an existing online poll (act 334; FIG. 3C).

If the first processing device determines that the subscriber is requesting to add a new online poll, then the first processing device may determine whether the subscriber is allowed to add the new online poll (act 336). For example, in some embodiments, a subscriber may be permitted to create only up to a predetermined number of online polls, such as, for example, five online polls, or another number of online polls. If the subscriber is not allowed to add the new online poll, then the first processing device may send an error message, via the network, to the second processing device for presentation to the subscriber (act 338) and the process may end.

If the subscriber is permitted to add the new online poll, the first processing device may request and receive poll information from the subscriber (act 340). In an embodiment consistent with the subject matter of this disclosure, the first processing device may cause a form to be presented to the subscriber via the network and the second processing device. The subscriber may complete the form and submit the form to the first processing device via the second processing device and the network. The form may request the subscriber to provide information including, but not limited to: a poll title; a poll question; two or more poll answers, one or more entrance criteria (for example, age, gender, race, country, state, county, city, zip code, e-mail address, domain name of the e-mail address, username, family income, marital status, contest ranking category (based on participation in one or more online contests or one or more online polls), number of submissions for a poll, or other entrance criteria), poll access control information, a poll category, a poll start date, or a poll end date. In some embodiments, the subscriber may further submit at least one image, which may be displayed to users participating in the poll. In other embodiments, the subscriber may provide different or other information when creating a poll.

The poll title may be a brief description or title of the poll. The poll question may include a question and a set of rules for responding to the question. The poll answers may be multiple choice. In some embodiments, a maximum number of allowed answers may be predefined, or may be adjustable based on a number of different criteria, such as, for example, a subscriber's ranking, or other criteria. The poll category may include a number of different categories, such as, for example, entertainment, mathematics, politics, social, sports, or other or different categories. The poll start date may be a date, upon which users may join the poll and submit or change their votes. The poll end date may be a date, upon which, users may no longer join the poll, vote, or change their vote. Results of the poll may be posted after the poll end date.

Although the entrance criteria may control participation in a poll by a user, the entrance criteria may not prevent users from viewing the poll and submitted votes. The poll access control information may provide a subscriber, such as a poll creator/designer, a way to restrict viewing and/or voting in the poll. In one embodiment, the access control information may include an access list including user names or e-mail addresses of users the subscriber wishes to permit to vote in a poll. In some embodiments, the access control information may further include a password or an access code, which a user may be required to provide in order to be permitted to participate in or view the online poll.

After the first processing device receives the poll information, the first processing device may add the poll information to a database (act 342). The first processing device may then redirect the subscriber to another page, such as, for example, a poll preview page (act 344), or another page. The poll preview page may provide the subscriber with a preview of how the poll may be presented to users who wish to vote in the poll.

If, during act 334, the first processing device determines that the subscriber requests editing of poll information of an existing poll, then the first processing device may determine whether the subscriber is allowed to edit the poll information (act 346). For example, in some embodiments, the subscriber may not be permitted to edit the poll information after the poll start date. In other embodiments, the subscriber may not be permitted to edit the poll information after the poll end date. In some embodiments, the subscriber may not be permitted to edit the poll information when other conditions are determined to exist.

If the first processing device determines that the subscriber is not allowed to edit poll information, then an error message may be provided by the first processing device to the second processing device, via the network, for presentation to the subscriber (act 348). Otherwise, the first processing device may retrieve the poll information from a database (act 350; FIG. 3D) and may provide the poll information to the second processing device, via the network, for presentation to the subscriber and for the subscriber to provide updated poll information (act 352). The second processing device may then receive updated poll information from the subscriber and may provide the updated poll information to the first processing device via the network (act 354). The first processing device may then update the poll information in the database for the online poll (act 356). The first processing device may then send information to the second processing device to redirect the subscriber to another page, such as, for example, the preview poll page, or another page (act 358).

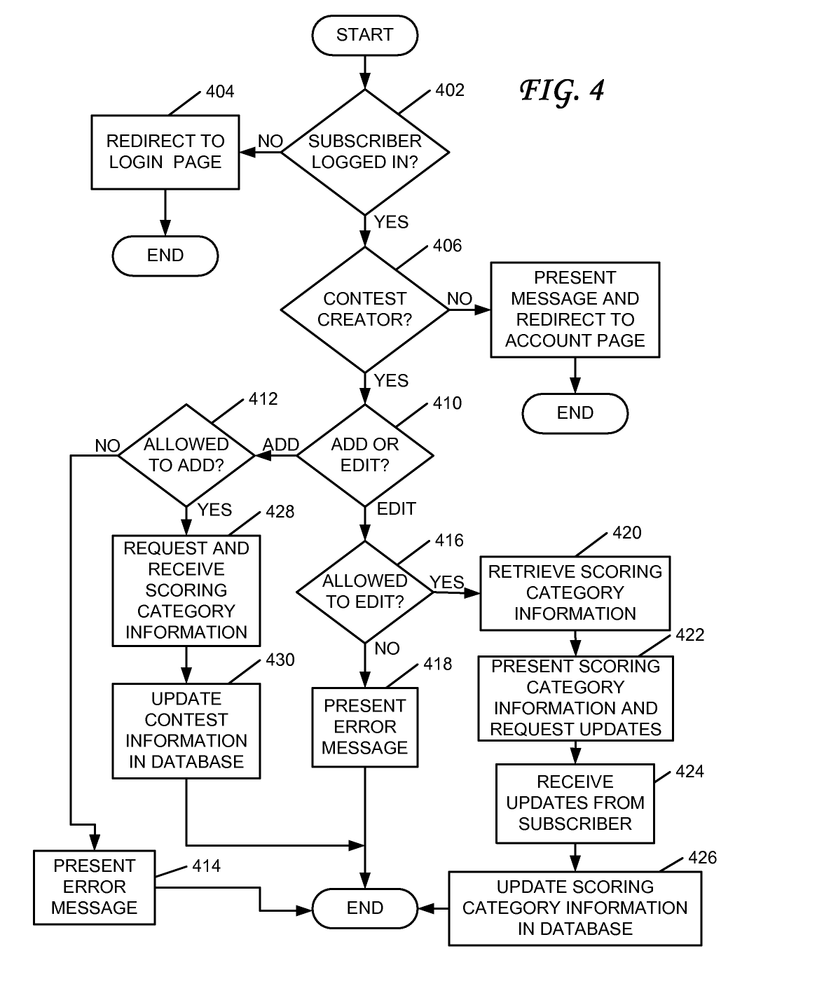

FIG. 4 is a flowchart illustrating an exemplary process for creating a scoring category. In some embodiments, act 318 of FIG. 3A may be implemented according to the flowchart of FIG. 4.

The process may begin with a first processing device, such as, for example, first processing device 102, determining whether a subscriber, who requested creation of a contest scoring category, is logged in to the first processing device (act 402). If the subscriber is not logged in to the first processing device, then the first processing device may send information to a second processing device, such as, for example, second processing device 104, through which the subscriber may be presented with another page, such as, for example, a login page, for logging in to the first processing device (act 404) or another page.

If, during act 402, the first processing device determines that the subscriber is logged in, then the first processing device may determine whether the subscriber is a contest creator/designer of an online contest for which the subscriber is requesting to create the scoring category (act 406). If the subscriber is not a contest creator/designer, then the first processing device may send a message, via the network, to a second processing, such as, for example, second processing device 104, for presentation to the subscriber, and the first processing device may further send information redirecting the second processing device to display another page to the subscriber, such as, for example, the account page (act 408) or another page.

If, during act 406, the first processing device determines that the subscriber is the contest creator/designer, then the first processing device may determine whether the subscriber is requesting to add the contest scoring category or edit the contest scoring category (act 410). If the subscriber is adding the contest scoring category, then the first processing device may determine whether the subscriber is allowed to add the contest scoring category (act 412). For example, in some embodiments, the subscriber may be permitted to define up to a predetermined number of contest scoring categories for a contest, and when the subscriber attempts to exceed the predetermined number of contest scoring categories, the first processing device may not allow the user to add the contest scoring category.

If the subscriber is not permitted to add the contest scoring category, then the first processing device may provide error information to the second processing device, via the network, for presentation to the subscriber (act 414) and the process may end.

If, during act 412, the first processing device determines that the subscriber is allowed to add the contest scoring category, then the first processing device may request and receive contest scoring category information from the subscriber (act 428). The contest scoring category information may include information as previously described with respect to FIG. 3, or may include other or different information. In one embodiment consistent with the subject matter of this disclosure, the first processing device may cause a form to be presented to the subscriber, via the network and the second processing device, requesting the contest scoring category information. The contest scoring category information may be sent to the first processing device, which may then update the contest information in the database (act 430).

If, during act 410, the first processing device determines that the subscriber is requesting to edit the contest scoring category, then the first processing device may determine whether the subscriber is allowed to edit the contest scoring category (act 416). For example, in some embodiments, the subscriber may not edit the contest scoring category after a contest end date.

If the subscriber is not permitted to edit the contest scoring category, then the first processing device may provide error information to the second processing device, via the network, for presentation to the subscriber (act 418) and the process may end.

If the subscriber is permitted to edit the contest scoring category, then the first processing device may retrieve the contest scoring category information from the database (act 420) and may provide the contest scoring category information to the second processing device, via the network, for presentation to the subscriber and for receiving updates to the contest scoring category information from the subscriber (act 422). In one embodiment, the scoring category information may be presented as a form, which the subscriber may update. The first processing device may receive updated contest scoring category information from the second processing device via the network (act 424). The first processing device may then update the contest scoring category information in the database (act 426).

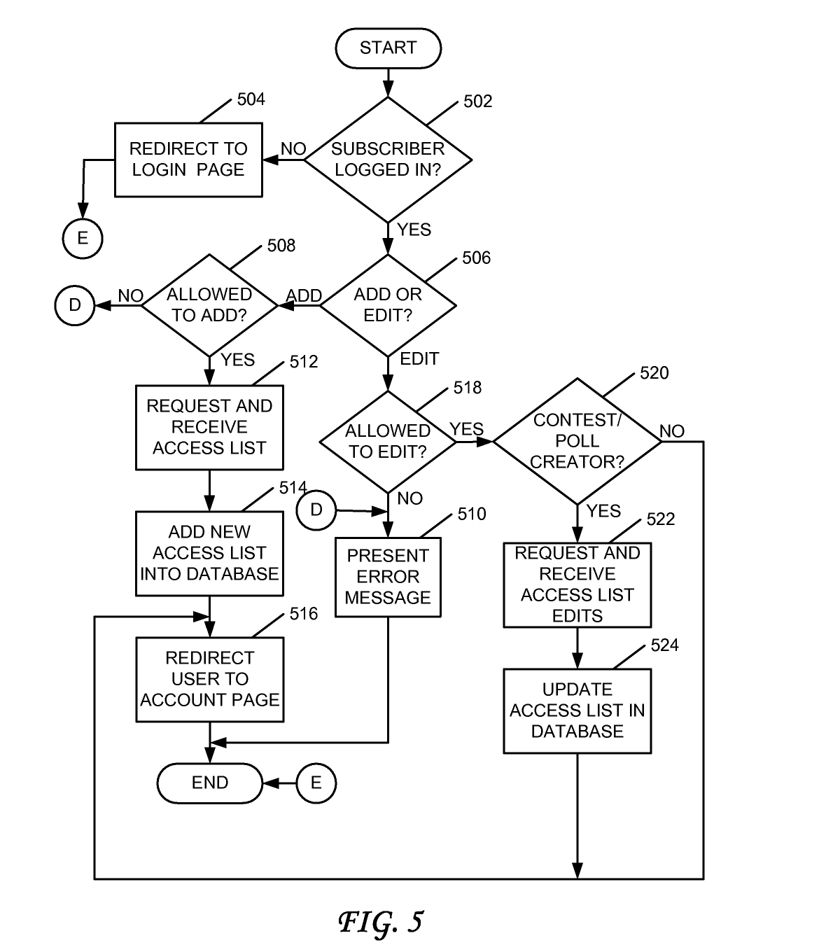

As mentioned above, in some embodiments, the subscriber may create one or more access lists, which may be assigned to an online contest or an online poll to restrict access and/or participation in the online contest or the online poll. FIG. 5 is a flowchart illustrating an exemplary process for creating an access list. After a subscriber has requested creation of an access list, the first processing device, such as, for example, first processing device 102, may determine whether the subscriber is logged in to the first processing device via a second processing device, such as second processing device 104, through a network, such as, for example, network 106 (act 502). If the subscriber is not logged in to the first processing device, then the first processing device may send information to a second processing device, such as, for example, second processing device 104, through which, the subscriber may be presented with another page, such as, for example, a login page for logging in to the first processing device (act 504) or another page. The process may then end.

If, during act 502, the first processing device determines that the subscriber is logged in, then the first processing device may determine whether the subscriber is requesting to add a new access list or edit an existing access list (act 506). If the subscriber is adding a new access list, then the first processing device may determine whether the subscriber is allowed to add a new access list (act 508). For example, in some embodiments, the subscriber may be permitted to define up to a predetermined number of access lists, and when the subscriber attempts to exceed the predetermined number of access lists, the first processing device may not allow the user to add the access list. If, the first processing device determines that the subscriber may not add a new access list, then the first processing device may provide error information to the second processing device, via the network, for presentation to the subscriber (act 510) and the process may end.

If the first processing device determines that the subscriber may add a new access list, then the first processing device may request and receive access list information from the subscriber (act 512). In an embodiment consistent with the subject matter of this disclosure, the first processing device may cause a form to be presented to the subscriber, via the network and the second processing device, for the subscriber to provide information for the access list. The access list may include user names, e-mail addresses of users of which the subscriber wishes to permit access, or other information.

After receiving information for the access list, the first processing device may add the access list to a database (act 514). The first processing device may then redirect the subscriber to another page, such as, for example, the account page, or another page (act 516) and the process may end.

If, during act 506, the first processing device determines that the subscriber is requesting to edit an access list, then the first processing device may determine whether the subscriber is allowed to edit the access list (act 518). For example, in one embodiment, the subscriber may not be permitted to edit an access list if the subscriber cannot provide a particular password or access code. In other embodiments, the subscriber may not be permitted to edit an access list for other reasons.

If the first processing device determines that the subscriber is not allowed to edit the access list, then an error message may be provided by the first processing device to the second processing device, via the network, for presentation to the subscriber (act 510) and the process may end.

If, during act 518, the first processing device determines that the subscriber is allowed to edit the access list, then the first processing device may determine whether the subscriber is a contest creator/designer or a poll creator (act 520). If the first processing device determines that the subscriber is not a contest creator/designer and not a poll creator, then the first processing device may redirect the subscriber to another page, such as, for example, the account page, or another page (act 516) and the process may end. Otherwise, the first processing device may request and receive updated access list information from the subscriber via the second processing device and the network (act 522). In an embodiment consistent with the subject matter of this disclosure, the first processing device may cause a form to be presented to the subscriber, via the network and the second processing device, for the subscriber to provide information for the updated access list. After receiving the access list information from the subscriber, the first processing device may update the access list information in the database (act 524). The first processing device may then redirect the subscriber to another page, such as, for example, the account page, or another page (act 516) and the process may end.

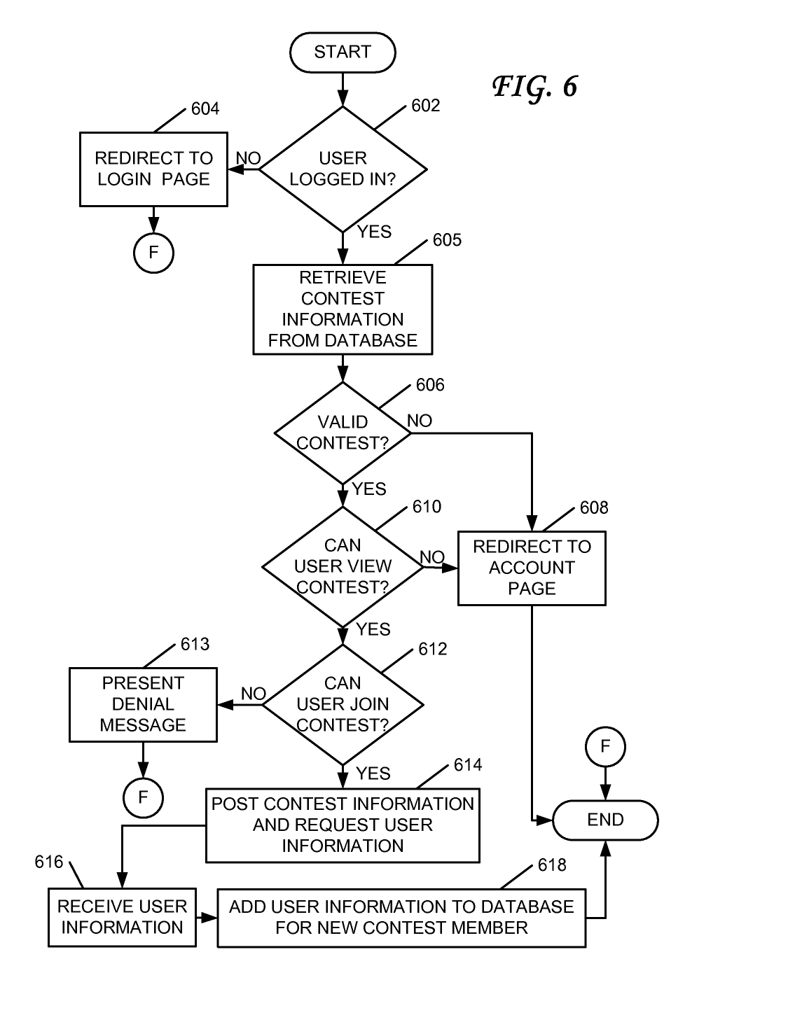

FIG. 6 is a flowchart illustrating an exemplary process in which a user requests access to join an online contest. The process may begin after the user sends a request from a second processing device, such as, for example, second processing device 104, to a first processing device, such as, for example, first processing device 102, via a network, such as, for example, network 106. After receiving the request, the first processing device may determine whether the user is logged in to the first processing device (act 602). If the user is not logged in to the first processing device, then the first processing device may cause the user to be presented with another page, such as, for example, a login page, through which the user may login to the first processing device (act 604) and the process may end. Otherwise, the first processing device may retrieve contest information from a database (act 605) and may determine whether the contest is a valid contest (act 606). An example of a valid contest is a contest that is currently active, such as, a contest after a start date, but before an end date. If the first processing device determines that the contest is not a valid contest, then the first processing device may redirect the user to another page, such as, for example, an account page, which may provide the user with information about his/her account, or another page (act 608). The process may then end.

If, during act 606, the first processing device determines that the contest is a valid contest, then the first processing device may determine whether the user can view the contest (610). As mentioned previously, a contest creator/designer may specify who is permitted to view a contest. If the user is not permitted to view the contest, then the first processing device may redirect the user to another page, such as, for example, the account page or another page (act 608) and the process may then end.

If, during act 610, the first processing device determines that the user is permitted to view the contest, then the first processing device may determine whether the user is permitted to join the contest (act 612). As mentioned previously, a contest creator/designer may specify who is permitted to participate in a contest. If the user is not permitted to join the contest, then the first processing device may send information to the second processing device, via the network, such that a message indicating a denial, with respect to joining the contest, (act 613) may be presented to the user. The process may then end.

If, during act 612, the first processing device determines that the user is permitted to join the contest, then the first processing device may obtain contest information and may forward the contest information to the second processing device, via the network, such that the contest information may be presented to the user along with a request for user information (act 614). The user may then provide information to the first processing device, via the second processing device and the network (act 616). The second processing device may receive the user information and may add the user information to a database (act 618). In some embodiments, the user information may include a contest submission. The contest creator/designer may have provided a category with respect to the contest, which may indicate a format for contest submissions. In such an embodiment, the first processing device may validate whether the contest submission is in a particular format. If the contest submission is not in the particular format, the first processing device may cause a message to be presented to the user, via the network and the second processing device, indicating that the contest submission was in an improper format.

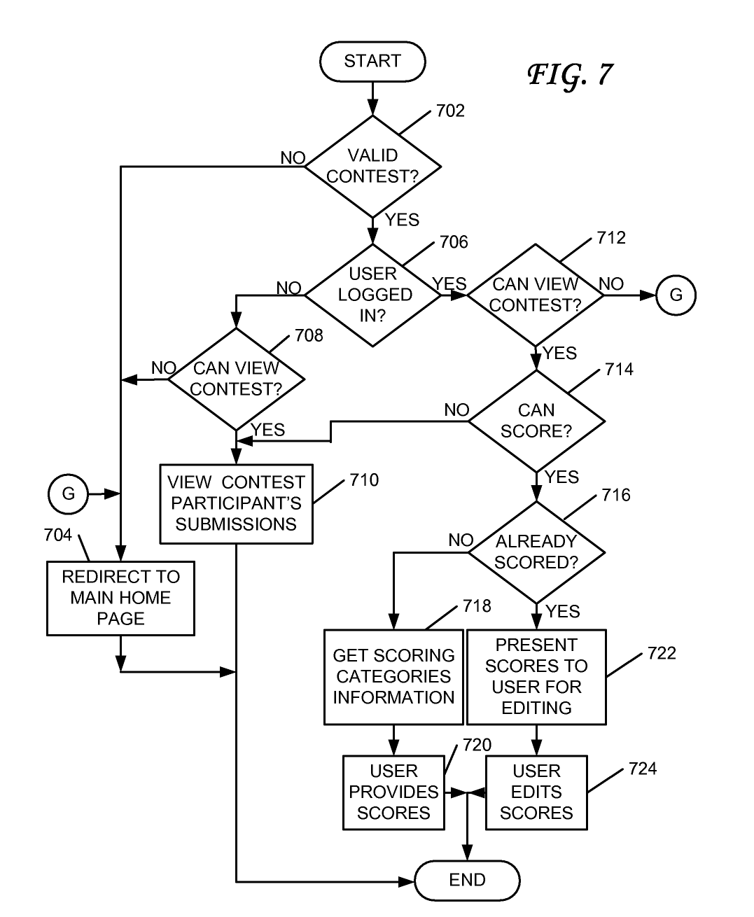

FIG. 7 is a flowchart of an exemplary process, which may be performed in embodiments consistent with the subject matter of this disclosure, when a user requests access to score and view a contest. After the user requests access to score and view a contest from the second processing device, the first processing device may receive the request and may determine whether the contest is a valid contest (act 702). If the first processing device determines that the contest is not a valid contest, then the first processing device may redirect the user to another page, such as, for example, a main page, which may provide the user with information about contests and/or polls in which the user may participate, or another page (act 704). The process may then end.

If, during act 702, the first processing device determines that the contest is a valid contest, then the first processing device may determine whether the user is logged in to the first processing device (act 706). If the first processing device determines that the user is not logged in, then the first processing device may determine whether the user is permitted to view the contest (act 708). As previously mentioned, a contest creator/designer may indicate who is permitted to view a contest. If the first processing device determines that the user is not permitted to view the contest, then the first processing device may redirect the user to another page, such as, for example, the main page, which may provide the user with information about contests and/or polls in which the user may participate (act 704) and the process may then end.

If, during act 708, the first processing device determines that the user is permitted to view the contest, then the first processing device may retrieve information regarding contest participants' submissions and may send the information to the second processing device, via the network, for presentation to the user (act 710). The process may then end.

If, during act 706, the first processing device determines that the user is logged in, then the first processing device may determine whether the user is permitted to view the contest (act 712). If the first processing device determines that the user is not permitted to view the contest, then the first processing device may redirect the user to another page, such as, for example, a main page, which may provide the user with information about contests and/or polls in which the user may participate (act 704), or another page and the process may then end.

If, during act 712, the first processing device determines that the user is permitted to view the contest, then the first processing device may determine whether the user is permitted to score contest submissions (act 714). As previously mentioned, a contest creator/designer may indicate which users are permitted to score contest submissions. If the first processing device determines that the user is not permitted to score contest submissions, then the first processing device may retrieve information regarding contest participants' submissions and may send the information to the second processing device, via the network, for presentation to the user (act 710) and the process may then end.

If, during act 714, the first processing device determines that the user is permitted to score contest submissions, then the first processing device may determine whether the user already scored a contest submissions (act 716). If the first processing device determines that the user did not already score contest submissions, then the first processing device may obtain contest scoring category information from a database and may send the contest scoring category information to the second processing device, via the network, for presentation to the user (act 718). The user may then view the contest scoring category information and may provide one or more scores via the second processing device, which may be forwarded to the first processing device via the network (act 720).

If, during act 716, the first processing device determines that the user already scored contest submissions, then the first processing device may obtain the scores, previously provided by the user, and may send them to the second processing device, via the network, for presentation to the user for editing (act 722). The user may then edit the scores via the second processing device, which may then send the edited scores to the first processing device, via the network (act 724).

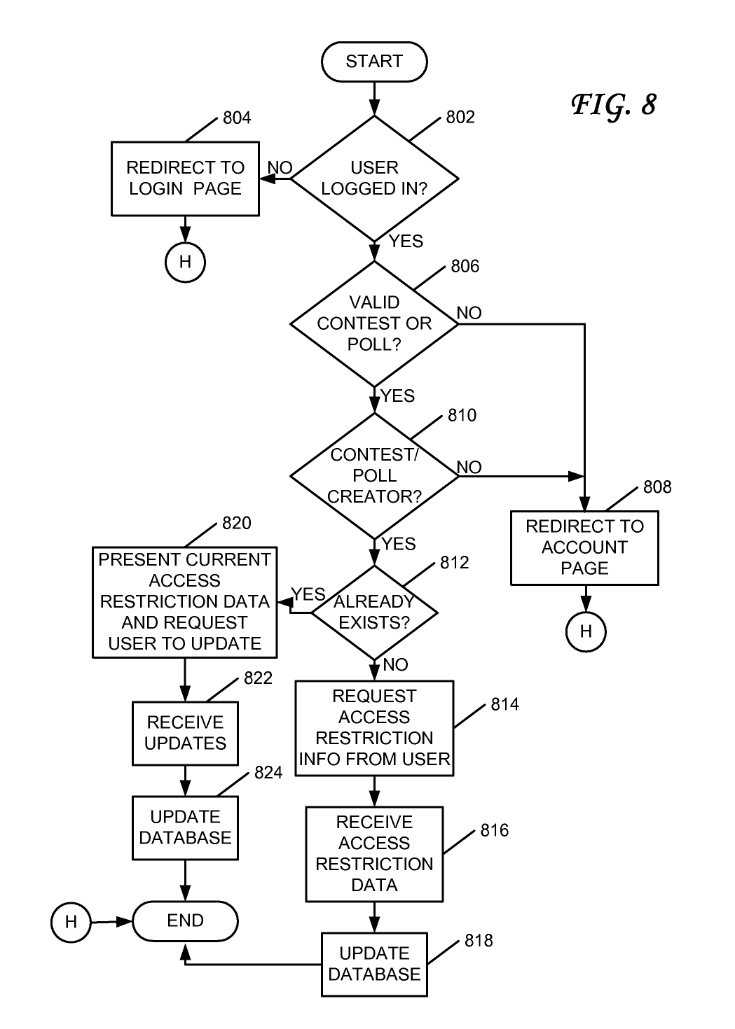

FIG. 8 is a flowchart of an exemplary process, which may be performed in embodiments consistent with the subject matter of this disclosure, when a user requests access to assign an access restriction to an online contest or an online poll. After receiving a user request to assign an access restriction, a first processing device, such as, for example, first processing device 102, may determine whether the user is logged in (act 802). If the user is not logged in to the first processing device, then the first processing device may send information to a second processing device, such as, for example, second processing device 104, through which, the user may be presented with another page, such as, for example, a login page for logging in to the first processing device (act 804) and the process may end.

If the first processing device determines that the user is logged in, then the first processing device may determine whether the online contest or the online poll, to which the user wishes to assign the access restriction, is a valid contest or poll (act 806). An example of a valid contest or poll is a contest or poll that is currently active, such as, a contest or poll after a start date, but before an end date. If the first processing device determines that the online contest or the online poll is not valid, then the first processing device may redirect the user to another page, such as, for example, an account page, which may provide the user with information about his or her account, or another page (act 808). The process may then end.

If, during act 806, the first processing device determines that the online contest or the online poll is valid, then the first processing device may determine whether the user is a creator/designer of the online contest or the online poll (act 810). If the first processing device determines that the user is not the creator/designer of the online contest or the online poll, then the first processing device may perform act 808, as discussed above.

If, during act 810, the first processing device determines that the user is the creator/designer of the contest or the poll, then the first processing device may determine whether the contest or the poll already has access restrictions assigned (act 812). If the first processing device determines that access restrictions are not already assigned to the online contest or the online poll, then the first processing device may request and receive access restriction information from the user (act 814). In one embodiment, the first processing device may send information to the second processing device, via the network, such that a form may be presented to the user via the second processing device. The form may specifically request information from the user with respect to the access restriction information, including, but not limited to, user names, e-mail addresses, domain names, or other information. The first processing device may then receive the access restriction information (act 816) and may update a database (act 818).

If, during act 812, the first processing device determines that the access restriction information already exists, then the first processing device may retrieve the access restriction information from the database, and may provide the access restriction information to the second processing device, via the network, for presentation to the user, such that the user may update the access restriction information (act 820). The first processing device may then receive the updated access restriction information (act 822) and may update the database (act 824). The process may then end.

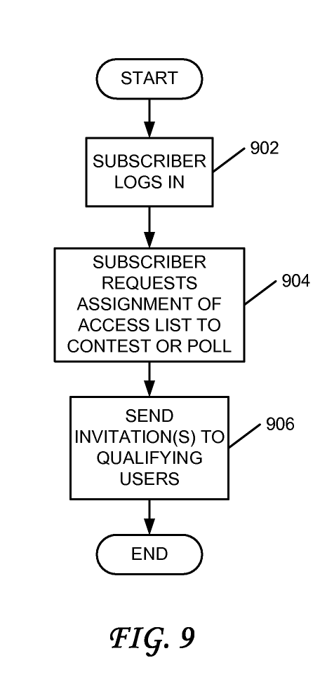

FIG. 9 is a flowchart illustrating an exemplary process, which may be performed in embodiments consistent with the subject matter of this disclosure, when a subscriber requests assignment of an access list to an online contest or an online poll and sending of an invitation to users on the access list. The process may begin with a subscriber logging in to a first processing device, such as, for example, first processing device 102, from a second processing device, such as, for example, second processing device 104, via a network, such as, for example, network 106 (act 902). The subscriber may then request an existing access list to be assigned to a contest or poll (act 904). In this example, we assume that the subscriber is a poll or contest creator/designer. The subscriber may make the request to the first processing device via the second processing device and the network. The first processing device may receive the request and may send invitations to qualifying users (act 906). In one embodiment, the first processing device may send invitations via e-mail, using e-mail addresses corresponding to the user information included in the access list. In another embodiment, the access list may include information such as age, gender, religion, family income, city, state, or other information. In such an embodiment, the processing device may send invitations to users satisfying the access list, such as, users living in a particular state, or city, or users satisfying another condition as specified in the access list. The invitations may be sent by the first processing device via e-mail, instant messaging, text messaging to a wireless communication device, such as a mobile phone, or other device, voicemail, or via other communication method.

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. For example, implementations consistent with the subject matter of this disclosure may have more or fewer acts than as described, or may implement acts in a different order than as shown. Accordingly, the appended claims and their legal equivalents should only define the invention, rather than any specific examples given.

1. A machine-implemented method for defining an online contest or an online poll, the method comprising:
providing an online facility for a designer to enter a description of the online contest or the online poll;
providing an online facility for the designer to enter entrance criteria for users to participate in the online contest or the online poll;
providing an online facility for the designer to enter a start date and an end date for the online contest or the online poll; and
providing an online facility for a designer to change a status of the online contest or the online poll.

2. The machine-implemented method of claim 1, wherein the method is for defining the online contest, and the method further comprises:
providing an online facility for the designer to enter a set of contest rules, the set of contest rules including information with respect to one or more prizes and how to win the one or more prizes.

3. The machine-implemented method of claim 1, wherein the method is for defining the online contest, and the method further comprises:
providing an online facility for the designer to enter information with respect to who is permitted to score contest entries.

4. The machine-implemented method of claim 1, wherein the method is for defining the online contest, and the method further comprises:
providing an online facility for the designer to create at least one contest scoring category.

5. The machine-implemented method of claim 1, wherein the method is for defining the online contest, and the method further comprises:
providing an online facility for the designer to specify a format for a contest submission to be provided by a contest participant, and
validating that the contest submission provided by the contest participant conforms to the specified format.

6. The machine-implemented method of claim 1, wherein the method is for defining the online poll, and the method further comprises:
providing an online facility for the designer to define the online poll question, at least two poll answers and a set of rules.

7. The machine-implemented method of claim 1, wherein the method is for defining the online poll, and the method further comprises:
providing an online facility for the designer to control access to the online poll by a user.

8. A system for providing a service to subscribers, the system comprising:
at least one processor;
a memory including instructions for the at least one processor;
a bus connecting the at least one processor with the memory; and
a communication interface for communicating with other processing devices via at least one network, the memory comprising:
instructions for permitting a subscriber to dynamically define an online contest or an online poll, and
instructions for permitting the subscriber to control participation of users of the system in the online contest or the online poll.

9. The system of claim 8, wherein the memory further comprises:
instructions for permitting the subscriber to dynamically define a method of scoring contest entries.

10. The system of claim 8, wherein the instructions for permitting the subscriber to control participation of users of the system in the online contest or the online poll further comprises:
instructions for permitting the subscriber to dynamically define one or more aspects of desired participants of the online contest or the online poll, and
instructions for permitting participation in the online contest or the online poll by only ones of the users of the system having the defined one or more aspects of the desired participants.

11. The system of claim 10, wherein the memory further comprises:
instructions for creating and sending a message to the ones of the users of the system having a user profile matching the one or more aspects of the desired profile defined by the subscriber to invite the ones of the users to participate in the online contest or the online poll.

12. The system of claim 8, wherein the memory further comprises:
instructions for permitting participation in the online contest or the online poll by ones of the users having a particular ranking based on participation in the one or more online contests or the one or more online polls.

13. The system of claim 8, wherein the memory further comprises:
instructions for permitting the subscriber to submit at least one image to be displayed to the users participating in the poll.

14. The system of claim 8, wherein the memory further comprises:
instructions for permitting the subscriber to define a permissible file format for a contest submission; and
instructions for validating a file format of a contest submission by a participating user.

15. A machine-implemented method for providing a service to a subscriber for dynamically creating an online contest or an online poll via a network, the method comprising:
receiving a first input from the subscriber via the network, the first input including a description of the online contest or the online poll;
receiving a second input from the subscriber via the network, the second input including a description of desired users for participating in the online contest or the online poll; and
making the online contest or the online poll available, via the network, to at least one user matching the description of desired users for participating in the online contest or the online poll.

16. The machine-implemented method of claim 15, wherein the receiving of a second input from the subscriber via the network further comprises:
receiving an access list including information with respect to the desired users for participating in the online contest or the online poll.

17. The machine-implemented method of claim 15, further comprising:
receiving a third input from the subscriber via the network, the third input including rules for scoring contest submissions.

18. The machine-implemented method of claim 15, further comprising:
receiving a third input from the subscriber via the network, the third input including information with respect to who is permitted to score contest entries.

19. The machine-implemented method of claim 15, wherein the second input includes demographic information with respect to the desired users for participating in the online contest or the online poll.

20. The machine-implemented method of claim 15, wherein the first input and the second input pertain to the online contest, and the method further comprises:
receiving a third input from the subscriber via the network, the third input including information indicating at least one user who is authorized to score contest submissions with respect to the online contest, and
receiving a fourth input from the subscriber, the fourth input including a scoring method for scoring the contest submissions.
